(19) United States
(12) Patent Application Publication
(10) Pub. No.: US 2005/0073285 A1
(43) Pub. Date: Apr. 7, 2005

(54) Circuit arrangement for voltage regulation

(75) Inventor: Andreas Schlaffer, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/970,363

(22) Filed: Oct. 21, 2004

Related U.S. Application Data
(63) Continuation of application No. PCT/DE03/01135, filed on Apr. 7, 2003.

(30) Foreign Application Priority Data
Apr. 23, 2002 (DE) 102 18 097.0

(51) Int. Cl. G05F 3/00

(52) U.S. Cl. 323/229

(57) ABSTRACT

Circuit arrangement for voltage regulation having a voltage divider and a regulating circuit. The voltage divider is arranged between a first potential and a reference-ground potential and has a plurality of diodes connected in series, wherein an output voltage is tapped off at a terminal of one of the diodes. The regulating circuit, to which the output voltage and a reference voltage are applied, regulates the first potential based on a comparison of the output voltage with the reference voltage. The divider ratio of the voltage divider is altered by activating or deactivating one or more of the diodes, and is additionally altered by setting a magnitude of a voltage drop across at least one of the diodes.

### CROSS-REFERENCE TO RELATED APPLICATION

This application is a continuation of International Patent Application Serial No. PCT/DE03/01135, filed Apr. 7, 2003, which published in German on Nov. 6, 2003 as WO 03/091818, and is incorporated herein by reference in its entirety.

### FIELD OF THE INVENTION

The present invention relates to a circuit arrangement for voltage regulation which enables a precise setting of a voltage.

### BACKGROUND OF THE INVENTION

The invention relates to a circuit arrangement for voltage regulation having a voltage divider, which is arranged between a first potential and a reference-ground potential and which has a multiplicity of diodes connected in series, wherein it is possible to tap off an output voltage at a terminal of a diode. The circuit arrangement also has a regulating circuit, to which the output voltage and a reference voltage are applied for the purpose of regulating the first potential on the basis of a comparison of the output voltage with the reference voltage, wherein it is possible to alter the divider ratio by activating or deactivating one or more diodes.

Such circuit arrangements for voltage regulation are used for example in integrated circuit arrangements in which a voltage is generated which is greater than the supply voltage of the integrated circuit. Such voltages are required for example in order to erase memory cells of a non-volatile memory, in particular EEPROM memories.

The problem that arises in this case is in regulating the potential difference between the first potential and the reference-earth potential, the potential difference being referred to as high voltage hereinafter. Since the high voltage lies above the supply voltage, it is not possible directly to measure and to regulate this high voltage. For this reason, voltage dividers are used, so that the measurement and regulation can be effected at a lower voltage level lying below the supply voltage.

Two different types of voltage dividers are usually used. If a precise setting possibility is required for the divider ratio, dividers are constructed from resistor chains. Individual resistors can be bridged in order to set the divider ratio. The fineness of the setting possibility results from the magnitude of the respectively bridged resistor in relation to the total resistance of the divider. However, such dividers have the disadvantage that the area requirement is comparatively large and this therefore constitutes an unfavourable solution from cost standpoints.

A more favourable solution with regard to the area requirement consists in constructing the voltage divider from diodes; in particular, dividers comprising MOS transistors each connected as a diode are known. In order to be able to use such a divider, however, it is a prerequisite that the minimum required setting granularity of the divider is greater than the threshold voltage of the transistors. In this case, the voltage is set by activating or deactivating individual diodes. If a realistic value of approximately 0.6 V is assumed for the threshold voltage of the transistors, the high voltage can only be set in steps of 0.6 V.

In order to be able to refine the setting granularity in the previous solution for realizing a voltage divider, the nominal voltage drop across a divider element must be reduced, so that, by means of the activation or deactivation of the divider element, the total voltage can be altered by a voltage drop of 0.2 V, for example. In such a case, however, diodes or MOS transistors can no longer be used since their threshold voltage is reached at 0.6 V and a voltage divider constructed in such a way is no longer functional below that.

### SUMMARY OF THE INVENTION

It is an object of the invention, therefore, to specify a circuit arrangement for voltage regulation which enables a precise setting of the voltage and which nevertheless has a small area requirement.

This object is achieved by means of a circuit arrangement of the type mentioned in the introduction which is characterized in that the divider ratio can additionally be altered by setting the magnitude of the voltage drop in the case of at least one of the diodes.

With regard to the voltage divider, the circuit arrangement according to the invention may be constructed completely from MOS transistors, which have a very small area requirement in comparison with resistors. The fineness of the setting of the divider ratio is achieved in that the coarse setting can be performed as before by activating or deactivating individual diodes and, moreover, the fine regulation is realized in that the voltage drop across one or more of the diodes can be set separately. Whereas a voltage drop of typically 0.6 V arises in the case of the diodes without additional circuitry, the parallel-connected transistor provided in accordance with a development of the invention means that this voltage drop can be set arbitrarily between 0 V and 0.6 V.

It is particularly advantageous that the current through the other diodes of the voltage divider is not altered as a result and the voltage drop across these diodes therefore remains the same. Therefore, the high voltage can always be calculated from a nominal voltage drop across the diodes and the voltage set across the at least one diode.

In an advantageous refinement of the invention, a control circuit is used for driving a transistor connected in parallel with a diode, the transistor being able to be driven by the control circuit in such a way that one of the terminals of the diode assumes a predetermined voltage.

### BRIEF DESCRIPTION OF THE DRAWINGS

The invention is explained in more detail below using an exemplary embodiment. In the figures:

FIG. 1 shows a circuit arrangement for voltage regulation according to the prior art; and

FIG. 2 shows a circuit arrangement for voltage regulation according to the invention.

### DETAILED DESCRIPTION OF THE PREFERRED MODE OF THE INVENTION

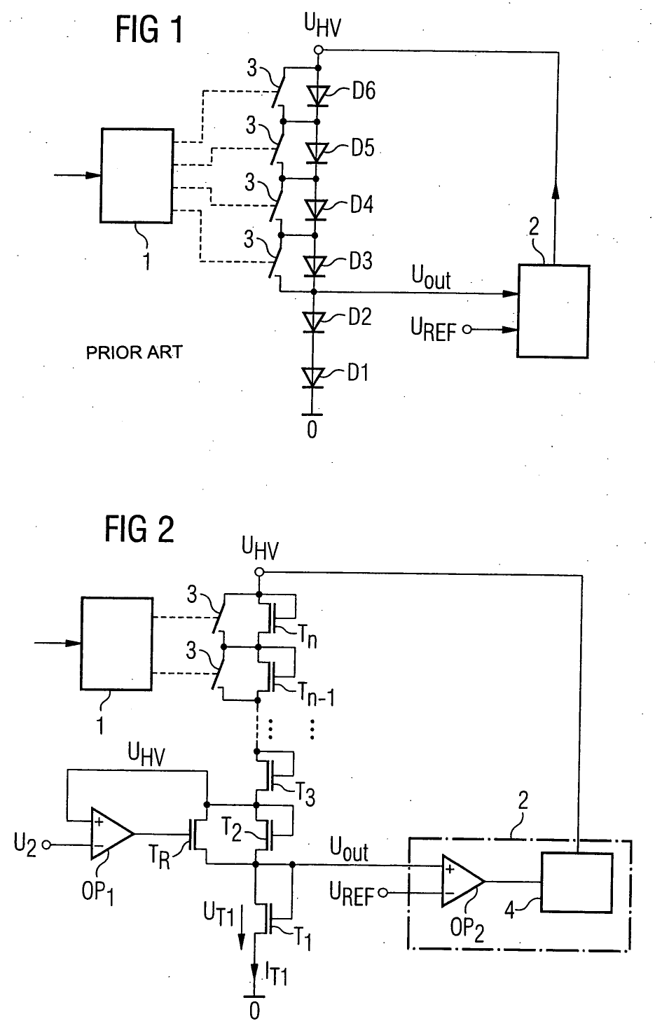

In order to facilitate the understanding of the invention, firstly a description will be given, with reference to FIG. 1, of how a circuit arrangement according to the prior art functions and of the causes of the problems which occur there. A voltage divider comprising the diodes D1 to D6 is connected between a high voltage U_{HV} and a reference-earth potential 0. The high voltage U_{HV} is divided uniformly between the diodes D1 to DG, provided that identical diodes are involved. Between the diodes D2 and D3, an output voltage Uₒᵤₜ is tapped off and fed to a regulating circuit 2. This arrangement forms a voltage divider for which the following holds true: Uₒᵤₜ=U_{HV}/3. In the regulating circuit 2, the measured voltage Uₒᵤₜ is compared with a reference voltage U_{REF}. In this case, U_{REF} is determined in such a way that it is one third of the desired high voltage. The regulating circuit 2 then readjusts the high voltage U_{HV} until the measured voltage Uₒᵤₜ corresponds to the reference voltage U_{REF}.

A different desired value for the high voltage U_{HV} can be set by altering the reference voltage value U_{REF}. What is problematic in this case, however, is that a change in U_{REF} is multiplied by the reciprocal of the divider ratio, in other words, in the present case, three times the change in U_{REF} acts on the high voltage U_{HV}. This is not problematic in the example shown since the divider ratio is 1:3 and the voltage changes of U_{REF} have to be comparatively large in order to obtain a specific change in U_{HV}. In a concrete embodiment of such a circuit, however, a divider comprises significantly more diodes. In the case of a desired high voltage of 16 V and a voltage drop of 0.6 V per diode, it is necessary to provide a divider having 26 diodes connected in series. A change in U_{REF} by 0.1 V thus results in a voltage change of 2.6 V for the high voltage U_{HF}. It is evident from this that an exact regulation of the high voltage Us is difficult.

A second possibility for changing the high voltage U_{HV} consists in changing the divider ratio of the voltage divider. A suitable means for doing this is to bridge individual diodes as a result of which the high voltage U_{HV} is in each case reduced by the magnitude of the voltage drop across a diode, that is to say generally 0.6 V. However, a finer gradation than 0.6 V is not possible in the case of such a circuit. Circuits of this type are nevertheless used in practice. A divider ratio control circuit 1 is provided for bridging one or more diodes D2 to D6 by means of a respective switch 3.

A finer gradation of the setting possibility cannot be obtained with such a circuit constructed with diodes since the threshold voltage of the diodes or transistors used is 0.6 V and cannot be undershot. Although the use of diodes with other semiconductor materials which have a threshold value lower than 0.6 V is conceivable, this is associated with an unjustifiable cost outlay.

A circuit arrangement for voltage regulation according to the invention is illustrated in FIG. 2. Here, too, a voltage divider is constructed by means of diodes, MOS transistors each connected as a diode being involved in the exemplary embodiment shown. These transistors connected as diodes are referred to just as diodes hereinafter. In order that the circuit arrangement illustrated is kept general, the topmost diode is designated generally by Tₙ and the diodes lying between T₃ and Tₙ₋₁ are indicated by dots. The output voltage Uₒᵤₜ is tapped off above the bottommost diode T₁. A regulating circuit 2 regulates the high voltage U_{HV} in such a way that the tapped-off voltage Uₒᵤₜ again corresponds to a reference voltage U_{REF}. In the adjusted state, the voltage UT, across the first diode T₁ is equal to the reference voltage U_{REF}. A current I_{T1} through the first diode T₁ is established in accordance with the diode characteristic curve. Since a series circuit is involved and the input resistance of the regulating circuit 2 tends towards infinity, the currents through all the diodes are identical, as a result of which identical voltage drops are also produced, provided that additional circuitry of the diodes is left out of consideration.

The regulating circuit 2 has an operational amplifier OP2 and also a charge pump circuit 4. The output voltage Uₒᵤₜ of the voltage divider is applied to the non-inverting input of the operational amplifier OP2. The reference voltage U_{REF} is applied to the inverting input of the operational amplifier OP2. Since the high voltage U_{HV} lies above the supply voltage of the circuit arrangement, the operational amplifier OP2 cannot provide the high voltage U_{HV} directly. Instead, it interacts with a charge pump circuit 4, the high voltage U_{HV} being provided at the output thereof. However, other embodiments are also conceivable for the regulating circuit 2, so that the arrangement shown here is to be understood as only by way of example.

In order to enable a finer setting than the abovementioned steps of 0.6 V, a transistor T_{R} is connected in parallel with the diode formed by T₂. By virtue of the transistor T_{R}, the voltage drop across the diode formed by T₂ can be reduced as desired. The consequence of this is that the divider ratio is not only determined from the ratio of the number of diodes across which the output voltage Uₒᵤₜ is tapped off to the total number of diodes, rather the magnitude of the voltage drop across the parallel circuit comprising T₂ and T_{R} has an influence as an additional analogue setting variable.

A major advantage of such an embodiment is that the sum of the currents through T₂ and T_{R} again corresponds to the current I_{T1}, so that the voltage drops across the other transistors connected as diodes are not altered.

In the present exemplary embodiment, the transistor T_{R} is driven by an operational amplifier OP1, whose non-inverting input is connected to the connection between the transistors T₂ and T₃. A control voltage U₂ is applied to the inverting input of the operational amplifier OP1. In this way, the voltage U₂ is impressed at the junction point between the transistors T₂ and T₃ since the operational amplifier OP1 alters the current through the transistor T_{R} until the voltage U₂ occurs precisely at the junction point between T₂ and T₃.

In this case, U2 can be set in such a way that U_{REF} is not undershot and 2·U_{REF} is not exceeded. The following holds true in this case:
U_{HV}=U₂+(n−2)·U_{REF}.

Thus, the regulation bandwidth only lies between 0 V and 0.6 V, which is insufficient, of course, in practice. Therefore, as in the prior art, the possibility of deactivating individual transistors is additionally provided in order thereby to be able to set the high voltage U_{HV} in steps of 0.6 V. To that end, as in the circuit arrangement of FIG. 1, provision is made of a divider ratio controller 1 which drives switches 3 which each bridge a diode.

The fine regulation of the divider ratio is then effected by corresponding driving of the transistor T_{R} with the voltage U₂.

In contrast to a change in the reference voltage U_{REF}, in the case of the circuit according to the invention, a change in U₂ is not multiplied with the number of diodes of the divider. Therefore, small inadvertent deviations of U₂ do not lead to a large error in the high voltage U_{HV}.

In the event of an erroneous value of U₂ or an error in the regulating circuit formed by OP1 and T_{R}, the maximum expected error in the high voltage is comparatively low, i.e. it is a maximum of 0.6 V, provided that this is the envisaged voltage drop per diode.

1. A circuit arrangement for voltage regulation comprising:
a voltage divider, which is arranged between a first potential and a reference-ground potential and which has a plurality of diodes connected in series, wherein an output voltage is tapped off at a terminal of one of the diodes; and
a regulating circuit, to which the output voltage and a reference voltage are applied, and which regulates the first potential based on a comparison of the output voltage with the reference voltage,
wherein a divider ratio of the voltage divider is altered by activating or deactivating one or more of the diodes, and is additionally altered by setting a magnitude of a voltage drop across at least one of the diodes.

2. The circuit arrangement according to claim 1, wherein the diodes are formed by respective MOS transistors connected as diodes.

3. The circuit arrangement according to claim 1, wherein a second terminal of one of the diodes, whose first terminal is connected to the reference-earth potential, is provided for tapping off the output voltage.

4. The circuit arrangement according to claim 1, further comprising a first transistor connected in parallel with a first one of the diodes to set the voltage drop across this first diode.

5. The circuit arrangement according to claim 4, further comprising a second transistor, which is connected in parallel with a second one of the diodes, which is connected to the first diode, to lower the voltage drop across the second diode.

6. The circuit arrangement according to claim 4, further comprising a control circuit, which drives the first transistor connected in parallel with the first diode, and which has an operational amplifier via which the first transistor is driven such that one of the terminals of the first diode assumes a predetermined voltage.

7. The circuit arrangement according to claim 1, wherein the regulating circuit comprises:
an operational amplifier having a non-inverting input and an inverting input, wherein the output voltage is applied to the non-inverting input and the reference voltage is applied to the inverting input; and
a charge pump circuit, which charges an ouput voltage of the operational amplifier and outputs the first potential.

8. An integrated circuit comprising the circuit arrangement according to claim 1.

9. An integrated circuit comprising the circuit arrangement according to claim 2.

10. An integrated circuit comprising the circuit arrangement according to claim 3.

11. An integrated circuit comprising the circuit arrangement according to claim 4.

12. An integrated circuit comprising the circuit arrangement according to claim 5.

13. An integrated circuit comprising the circuit arrangement according to claim 6.

14. An integrated circuit comprising the circuit arrangement according to claim 7.
